(19) United States
(12) Patent Application Publication
(10) Pub. No.: US 2024/0174539 A1
(43) Pub. Date: May 30, 2024

(54) IONIZATION CHAMBER FOR PRODUCING HYDROGENATED WATER FROM A WATER MINERALIZATION AND FILTRATION SYSTEM

(71) Applicant: CORE PACIFIC INC., Houston, TX (US)

(72) Inventor: Patrick GWEN, Houston, TX (US)

(21) Appl. No.: 18/531,882

(22) Filed: Dec. 7, 2023

Related U.S. Application Data
(63) Continuation-in-part of application No. 18/175,998, filed on Feb. 28, 2023.
Application No. 18/175,998 is a continuation of application No. 17/815,479, filed on Jul. 27, 2022, now Pat. No. 11,597,669.

(51) Int. Cl. C02F 9/00; C02F 1/00; C02F 1/44; C02F 1/68

(52) U.S. Cl. CPC C02F 9/00; C02F 1/003; C02F 1/441; C02F 1/68; C02F 2201/005; C02F 2301/066; C02F 2307/06

(57) ABSTRACT

An ionization chamber for use with a water filtration system has a housing, a first electrode positioned in the housing, a second electrode positioned in the housing, a brine chamber formed in the housing, a filtered water chamber positioned in the housing, and an ion exchange membrane positioned between the brine chamber and the filtered water chamber. The housing has a first ingress adapted to pass filtered water into the housing and a second ingress adapted pass a brine from a reverse osmosis filter into the housing. The housing has a first egress adapted to pass hydrogenated water and a second egress adapted to pass brine. The ion exchange membrane is adapted to pass hydrogen ions from the brine to the filtered water as electrical charges are applied to the first and second electrodes.

### CROSS-REFERENCE TO RELATED APPLICATIONS

The present invention is a continuation-in-part of U.S. patent application Ser. No. 18/175,998, filed on Feb. 28, 2023, entitled. U.S. patent application Ser. No. 18/175,998 is a continuation of U.S. patent application Ser. No. 17/815,479, filed on Jul. 27, 2022, now issued as U.S. Pat. No. 11,597,669, on Mar. 7, 2023.

### FIELD OF THE INVENTION

The present invention relates to the hydrogenation of water. More particularly, the present invention relates to the use of reverse osmosis filters for the filtering of tap water. Moreover, the present invention also relates to a hydrogenation of pure water as passed from a reverse osmosis filter by using the brine from the reverse osmosis filter.

### DESCRIPTION OF RELATED ART

Hydrogen water is ordinary drinking water enriched with gaseous molecular hydrogen. Hydrogen water is tasteless and odorless. Hydrogen molecules in such water are, in no way, associated with water molecules. In other words, it contains hydrogen in its pure H₂ form. Therefore, the water formula does not change. Hydrogen water has pronounced therapeutic and wellness properties confirmed by numerous scientific studies on humans and animals. Today, more than 1500 studies worldwide, including the USA, Japan Korea, China, Serbia, Mexico, Germany and Slovakia, have been published on molecular hydrogen therapy and the study of hydrogen water effects on the human body.

In simple terms, aeration is typically saturated with CO₂ gas. In the production of hydrogen water, it is saturated with H₂ (hydrogen gas). Moreover, chemically, hydrogen is absolutely inert, i.e. it does not react or enter at high temperature or pressure. The hydrogen molecule has a high chemical potential, i.e. an effect on the biological and biochemical processes in the human body.

Today, according to research of the Molecular Hydrogen Institute, the most and influential international organization that deals with the therapeutic properties of hydrogen, more than 30% of the population of Japan and more than 20% of the South Korean population regularly use hydrogen water produced by a water machine.

The characteristics of hydrogen water include ORP (redox potential), pH, and the concentration of molecular hydrogen as measured in PPB/PPM. The negative oxidation-reduction potential (ORP) of hydrogen water can vary from 150 to 600 m V depending on how the process of saturation proceeds, the quality of water, its type, saltiness, etc. The pH value of hydrogen water, obtained using electrolysis technology and direct saturation (i.e. saturation with H₂), corresponds to the pH of the water that has been saturated. When receiving hydrogen water by direct electrolysis, the pH becomes slightly alkaline. The molecular hydrogen has extremely low water solubility. However, even under such conditions, its amount in water is sufficient for biochemical reactions. At normal atmospheric pressure, a maximum of 1.8 milliliters of hydrogen dissolves in approximately 1000 milliliters of water. This corresponds to approximately 1.8 parts per million.

In many scientific studies, molecular hydrogen exhibits anti-oxidant-like effects and properties. As of today, only three ways of antioxidant effect of molecular hydrogen have been studied. First, there is the inhibition of reactive oxygen species increase (free radicals). Hydrogen is able to inhibit and suppress the hydroxyl radical (OH) in human cells. Several pathways of molecular hydrogen exposure in the human body are already known with certainty. Secondly, the inhibition of reactive nitrogen species increased. The molecular hydrogen inhibits the formation of NO₂ which, in turn, suppresses the formation of ONOO— (peroxynitrite), which reduces oxidative stress. Thirdly, hydrogen water increases the regulation of powerful endogenous antioxidants. Human cells have their own natural defense system and produce the human body's own antioxidants, such as superoxide dismutase, catalase, and glutathione peroxidase. Hydrogen enhances the endogenous antioxidants by activating the Nrf2 keapl system through the properties of hydrogen signal modulations.

Hydrogen water also has an anti-inflammatory effect. Hydrogen has a profound effect on the immune system and inflammatory process in the human body. This is accomplished by reducing oxidative stress, lowering inflammatory cytokine levels, and increasing the important anti-inflammatory cytokine level, in the prevention of inflammation. Hydrogen has a unique ability to penetrate cells and even tiny structures inside cells (organelles), such as mitochondria and the nucleus. No other molecules can penetrate deep into the cells. Hydrogen water achieves various paths. These include inflammatory cytokines reduction (TNF-alpha and gamma, IL-6, IL-1 beta, IL-10, IL-12, NF-kB), cancer-causing genes decrease (decrease in caspase 3, caspace 12, caspace 8, Bcl-2, BAX), increased activity of genes associated with cancer (bFGF, HGF, IFNy), reduced activity of genes associated with inflammation (i-NOS, VEGF, CCL2, ICAM-1, PGE 2), energy metabolism increase (increased FGF21), increased ghretin, and detox genes activation (Nrf2 and heme-oxygenase-1).

A typical method of producing hydrogen-rich water occurs by electrolyzing water and dissolving the hydrogen gas in the water in order to produce the hydrogen-rich water. FIG. 1 illustrates such a system. Initially water 10 is directed to a prefilter 12. Water 10 can be in the nature of tap water. The prefilter 12 can be a screen, or other type of mechanical filter, that effectively separates large particulates from the remaining water. The pretreatment filter also can be an activated carbon filter, such as activated carbon filter 14. In FIG. 1, the prefiltered water passes from the pre-filter 12 into the activated carbon filter 14. The activated carbon filter 14 filters in a bed of activated carbon. The activated carbon filter 14 removes impurities through adsorption. It removes some chlorines particles (such as sediment) and some volatile organic compounds. The activated carbon filter 14 does not effectively filter inorganics, fluorides, or cyanide. The prefiltered water will pass through a line 16 into the activated carbon filter 14. The filtrate from the activated carbon filter 14 will pass along line 18 to an ionizer 20. Ionizer 20 is part of an electrolysis unit. This water is delivered to the ionizer. The ionizer will produce an output of hydrogen 22 and an output of oxygen 24. The output will be approximately 50% hydrogen and approximately 50% oxygen.

The hydrogen water that is produced for the as the hydrogen output 22 will be very effective for use as a hydrogenated drinking water. However, the oxygenated water 24 would be simply discarded since it contains undesirable oxygen therein.

One of the problems associated with the prior art system shown in FIG. 1 is that a large number of suspended solids and impurities will pass from the activated carbon filter 14 into the ionizer 20. These dissolved solids can include minerals, salts, metals, cations or ions. They can also include inorganic salts, calcium, magnesium, potassium, sodium, bicarbonates, chlorides and sulfites. Ultimately, these total dissolved solids can flow to the ionizer 20. As such, it is desirable to remove such dissolved solids from the products produced from the ionizer 20.

Reverse osmosis filters have not been used, in the past, for the production of hydrogen water. The reason is that the reverse osmosis filter passes a very small percentage of the permeate from the original water. The remainder of the contaminant-containing water passes outwardly of the reverse osmosis filter as brine. If the completely filtered total dissolved solids-free water passes into the ionizer, then the ionizer becomes very ineffective at separating the hydrogen and oxygen components. The ions associated with the total dissolved solids are important in the electrolysizing of the water. As such, in the past, it was necessary to avoid the reverse osmosis filter since the ionizer would become relatively ineffective. It was necessary to avoid the reverse osmosis filter in order to enhance the performance of the ionizer. Additionally, in the prior art, there is a substantial amount of waste water since approximately 50% of the water from the ionizer must be removed since it contains the impurities and salts. In areas where water supply is scarce, this waste water would be unacceptable.

In the past, various patents and patent application publications have issued with respect to the hydrogenation of drinking water. For example, U.S. Pat. No. 8,974,646, issued on Mar. 10, 2015 to Park et al., describes a portable hydrogen-rich water generator. This hydrogen-rich water generator includes a separable drinking cup, an electrolytic cell which includes an anode, a cathode, and a solid polymer electrolyte membrane and is disposed at the bottom of the drinking cup. A reservoir base allows the drinking cup to be mounted thereto. An anode reaction of the electrolytic cell is generated in the reservoir base. A float valve allows the water to be continuously supplied of a certain water level from a water tank. A power supply applies direct current power to the electrolytic cell. When power is applied after putting purified water into the drinking cup and mounting the drinking cup on the reservoir base, the electrolytic cell electrolysizes the water in the reservoir base so that oxygen is generated at the anode of the reservoir base side and hydrogen is generated at the cathode of the drinking cup side. This allows hydrogen gas is to be dissolved in the purified water in the drinking cup within a short time. As such a hydrogen-rich water is produced.

U.S. Pat. No. 9,120,672, issued on Sep. 1, 2015 to Satoh et al., describes a hydrogen-containing fluid obtained through storing a hydrogen generating system which contains a hydrogen generating agent within a hydrogen bubble forming implement. The hydrogen bubble forming implement has a gas/liquid separating section including a gas-permeable film or an open-close type valve so as to cause the hydrogen generating system and a general purpose water to react in the hydrogen bubble forming implement. A hydrogen gas is generated in the hydrogen bubble forming implement.

U.S. Pat. No. 9,511,331, issued in Dec. 6, 2016 to J. Agarashi, discloses a process for continuously producing hydrogen-containing water for drinking. This process includes the steps (a) filtering and purifying water as a raw material; (b) degassing the purified water supplied to a degasser; (c) dissolving hydrogen gas in the degassed water supplied to a hydrogen dissolution device; (4) sterilizing the hydrogen-dissolved water supplied to a sterilizer, (e) filling the hydrogen-containing water supplied to a filling device in a sealed container and transferring the filled water product to a heat sterilizer; and (f) heat-sterilizing the water product supplied to the heat sterilizer. A portion of the hydrogen-containing water is returned to the degasser.

U.S. Pat. No. 10,421,673, issued on Sep. 24, 2019 to Luo et al., teaches a simple and efficient electrolysis device for making electrolyzer water from pure water. This device comprises a controllable electrolysis power supply, and an electrolytic electrode power plate. The component is immersed within the to-be-electrolyzer water when in operation. A gap is provided between an anode and a cathode of the electrolytic electrode plate assembly. This electrolysis device is used for making electrolysized water from pure water.

U.S. Patent Application Publication No. 2003/0132104, published on Jul. 17, 2003 to Yamashita et al., provides a hydrogen-dissolved water production apparatus. A degassing device, a hydrogen dissolving device, and a palladium catalyst column are provided in that order downstream of a high-purity water production device. An impurity removal device is connected to the exit side of treated water of the palladium catalyst column. The impurity removal device removes impurity ions which are eluted into the water to be treated for impurity particles which mix in with the water to be treated during the treatment in the palladium catalyst column. The impurity removal device comprises an ion exchange device and a membrane treatment device, such as in ultrafiltration membrane device, a reverse osmosis membrane device, or the like.

U.S. Patent Application Publication No. 2005/0224996, published on Oct. 13, 2005 to Y. Yoshida, shows a hydrogen-reduced water and method for preparing such hydrogen-reduced water. A pressure vessel is filled with hydrogen gas. The pressure of the hydrogen gas in the pressure vessel is maintained within a predetermined range. Raw water is introduced into the pressure vessel. The raw water is introduced into the pressure vessel as a shower from a nozzle provided at the upper interior of the pressure vessel. After contacting hydrogen gas with the raw water in the pressure vessel and dissolving the hydrogen gas in the raw water, the water is packaged and sealed in a highly airtight container.

U.S. Patent Application Publication No. 2016/0083856, published a Mar. 24, 2016 to Iwatsu et al., shows an electrolytic treatment using treatment subject ions contained in a treatment liquid. The method includes an ion positioning step for positioning a direct electrode and a counter electrode so as to sandwich the treatment liquid and positioning an indirect electrode for forming an electric field in the treatment liquid. A treatment subject ion migration step applies a voltage to the indirect electrode and thereby moves the treatment subject ions in the treatment liquid to the counter electrode side. A treatment subject ion redox step applies a voltage between the direct electrode and the counter electrode so as to oxidize or reduce the treatment subject ions that has migrated to the counter electrode side.

It is an object of the present invention to provide a process and system for producing hydrogenated drinking water which has a relatively small footprint.

It is another object of the present invention to provide a process and system for producing hydrogenated drinking water which assures that the hydrogenated drinking water is uncontaminated.

It is another object of the present invention to provide a process and system for producing hydrogenated drinking water that has mechanical and pneumatic barriers to contamination.

It is another object of the present invention to provide a process and system for producing hydrogenated drinking water that requires a minimal amount of electricity.

It is another object of the present invention provide a process and system for producing hydrogenated drinking water which requires less water consumption.

It is another object of the present invention to provide a process and system for producing hydrogenated drinking water which produces a pure hydrogenated water output.

It is another object of the present invention to provide a process and system for producing hydrogenated drinking water which quickly hydrogenates the water.

It is another object of the present invention to provide a process and system for producing hydrogenated drinking water which provides the ability to use reverse osmosis filtration and to achieve the benefits of reverse osmosis filtration.

It is another object of the present invention to provide a process and system for producing hydrogenated drinking water which guarantees that no contaminants remain in the hydrogenated water.

It is a further object of the present invention to provide a process and system for producing hydrogenated drinking water which improves the health and well-being of a person drinking the hydrogenated water.

It is still another object of the present invention to provide a process and system for producing a hydrogenated drinking water that utilizes salts and ions from the brine of a reverse osmosis filter to improve the operation of the ionizer.

These and other objects and advantages of the present invention will become apparent from a reading of the attached specification and appended claims.

### BRIEF SUMMARY OF THE INVENTION

The present invention is an ionization chamber for use with the water filtration system. The ionization system comprises a housing having a first ingress and a second ingress, a first electrode positioned in the housing, a second electrode positioned in the housing, a first brine chamber formed in the housing, a first filtered water chamber positioned in the housing, and a first ion exchange membrane positioned between the first brine chamber and the first filtered water chamber. The first ingress is adapted to pass filtered water into the housing. The second ingress is adapted to pass a brine into the housing. The housing has a first egress and a second egress. The first egress is adapted pass hydrogenated water from the housing. The second egress is adapted to pass the brine from the housing. The first electrode is adapted to pass an electrical charge of a polarity. The second electrode is adapted to pass an electrical charge of another polarity. The first brine chamber communicates with the second ingress and the second egress of the housing. The first filtered water chamber communicates with the first ingress and the first egress of the housing. The ion exchange membrane is adapted to pass hydrogen ions from the brine of the filtered water as the electrical charges are applied to the first electrode and the second electrode.

In the present invention, each of the first electrode and the second electrode is a plate positioned so as to extend across at least a portion of the housing. The first brine chamber is defined by the plate of the first electrode and the first ion exchange membrane. The first filtered water chamber is defined by the first ion exchange membrane and the plate of the second electrode.

The brine chamber comprises a panel sandwiched between the first electrode and the first ion exchange membrane. The panel has at least one channel therein. This channel communicates with the second ingress and the second egress. The channel of the first brine chamber is of a serpentine configuration. The serpentine configuration is adapted to cause the brine to flow along the path of the serpentine configuration.

The first filtered water chamber includes another panel sandwiched between the first ion exchange membrane and the second electrode. This panel of the first filtered water chamber has at least one channel therein. The channel of the panel of the first filtered water chamber has a serpentine configuration. The serpentine configuration is adapted to cause the filter water to flow along the path of the serpentine configuration.

A power supply is electrically connected to the first electrode and the second electrode.

The ionization chamber of the present invention further comprises a second brine chamber formed in the housing on the side of the second electrode opposite the first filtered water chamber, a second ion exchange membrane positioned in the housing on the side of the second brine chamber opposite the second electrode, a second filtered water chamber formed in the housing on the side of the second ion exchange membrane opposite the second brine chamber, and a third electrode positioned in the housing on the side of the second filtered water chamber opposite the second ion exchange membrane. The third electrode is adapted to pass an electrical charge of a polarity opposite to a polarity of the electrical charge of the second electrode. The second brine chamber communicates with either the first brine chamber or with the second ingress. The second brine chamber communicates with the second egress. The second filtered water chamber communicates with the first filtered water chamber or with the first ingress. The second filtered water chamber is in communication with the first egress.

In an alternative embodiment, a second brine chamber, a second ion exchange membrane, a second filtered water chamber and a third electrode are arranged in a sandwiched configuration. The sandwiched configuration is positioned to a side of the first brine chamber, the first ion exchange membrane, the first filtered water chamber and the first and second electrodes. The second brine chamber is in communication with the first brine chamber. The second filtered water chamber is in communication with the first filtered water chamber. The ionic exchange membrane is a proton exchange membrane.

The present invention is also an apparatus for filtering and hydrogenating drinking water. This apparatus comprises a housing having a reverse osmosis filter positioned therein. The reverse osmosis filter is adapted to receive tap water and to pass a filtered water and a brine therefrom. An ionization chamber is positioned in the housing. The ionization chamber has a first ingress connected to a reverse osmosis filter so as to pass the filtered water from the reverse osmosis filter into the ionization chamber. The ionization chamber has a first ingress connected to the reverse osmosis filter so as to pass the filtered water from the reverse osmosis filter into the ionization chamber and a second ingress connected to the reverse osmosis filter so as to pass the brine from the reverse osmosis filter into the ionization chamber. The ionization chamber comprises a first electrode adapted to pass an electrical charge of a polarity, a second electrode positioned or adapted to pass an electrical charge of another polarity, a first brine chamber communicating with the second ingress and the second egress of the housing, a filtered water chamber communicating with the first ingress and the first egress, and an ion exchange membrane positioned between the brine chamber and the filtered water chamber. The ion exchange membrane is adapted to pass hydrogen ions from the brine to the filtered water as the electrical charges are applied to the first electrode and the second electrode.

In the apparatus of the present invention, each of the first electrode and the second electrode is a plate. The brine chamber is defined by the plate of the first electrode and the ion exchange membrane. The filtered water chamber is defined by the ion exchange membrane and the plate of the second electrode.

The brine chamber of the apparatus of the present invention includes a panel sandwiched between the first electrode and the ion exchange membrane. This panel has at least one channel therein. The channel communicates with the second ingress or the second egress. This channel is of a serpentine configuration. The serpentine configuration is adapted to cause the brine to flow along a path thereof. The filtered water chamber also includes another panel sandwiched between the ion exchange membrane and the second electrode. This panel has at least one channel therein. This channel communicates with the first ingress and the first egress. This channel also has a serpentine configuration adapted to cause the filtered water to flow along a path of the serpentine configuration. A power supply is electrically connected to the first electrode and the second electrode. The ionization chamber extends vertically within the housing. The first and second egresses extend outwardly of the housing.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE DRAWINGS

FIG. 1 is a block diagram showing the operation of a prior art system for producing hydrogenated water.

FIG. 2 is a block diagram showing a simplified version of the process and system of the present invention for producing a hydrogenated drinking water output.

FIG. 3 is a cross-sectional view showing a simplified configuration of the ionization chamber of the present invention.

FIG. 4 is an upper perspective view showing the filtering and mineralization system of the present invention.

FIG. 5 is an end view of the water filtering and mineralization system of the present invention.

FIG. 6 is a perspective view showing the internal components of the water filtering and mineralization system of the present invention.

FIG. 7 shows a perspective view of the interior components of the water filtering and mineralization system of the present invention.

FIG. 8 is a cross-sectional view showing the construction of the ionization chamber of the present invention of a simplified form.

FIG. 9 is an upper perspective view showing the ionization system as used in the water filtering and mineralization system of the present invention.

FIG. 10 is a perspective cut-away view of the ionization chamber as used in the water filtering and mineralization system of the present invention.

FIG. 11 is a perspective rearward view of the ionization chamber of the water filtering and mineralization system of the present invention.

FIG. 12 is an isolated plan view of one of the panels used for the flow of brine and/or filtered water within the ionization chamber of the present invention.

FIG. 13 is an upper perspective exploded view of the ionization chamber of the present invention.

### DETAILED DESCRIPTION OF THE INVENTION

Referring to FIG. 2, there shown the system 30 for the production of a hydrogenated water in accordance with the preferred embodiment of the present invention. System 30 includes a water supply 32. Water supply 32 can be in the nature of a tap water supply. A prefilter 34 is connected to the water supply 32 by a line 36. Pretreatment filter 34 can be in the nature of an activated carbon filter, a screen, a sand filter, or other device wherein particulate impurities in the water supplied from the water supply 32 are separated from the flow passing from the prefilter 34 into the activated carbon filter 38. This water will pass along line 40 into the activated carbon filter 38. The activated carbon filter 38 has a bed of activated carbon. This activated carbon filter 38 serves to remove impurities through adsorption. It removes some chlorines, particulates such a sediment, and volatile organic compounds. It does not effectively filter inorganics, fluoride, cyanide. The water passing through line 42 to reverse osmosis filter 44 will contain a certain amount of total dissolved solids (TDS). These total dissolved solids can include minerals, salts, metals, cations or anions. It also can include inorganic salts, calcium, magnesium, potassium, sodium, bicarbonates, chlorides and sulfites. Typically, a pump will be provided along line 42 or in cooperation with line 42 so as to apply a pressure of approximately 80 p.s.i. to the flow to the reverse osmosis filter 44.

The reverse osmosis filter 44 completely filters the impurities from the water. In particular, the reverse osmosis filter 44 will remove inorganics and fluorides. Generally, only the pure water molecules will get through and pass as permeate 46. The permeate 46 passes to an ionizer 48. Since the permeate 46 is pure water, it is too clean for the ionizer. There are no ions, minerals or salts for proper charging by the ionizer 48. The absence of such total dissolved solids from the permeate 46 will significantly reduce conductivity within the ionizer 48.

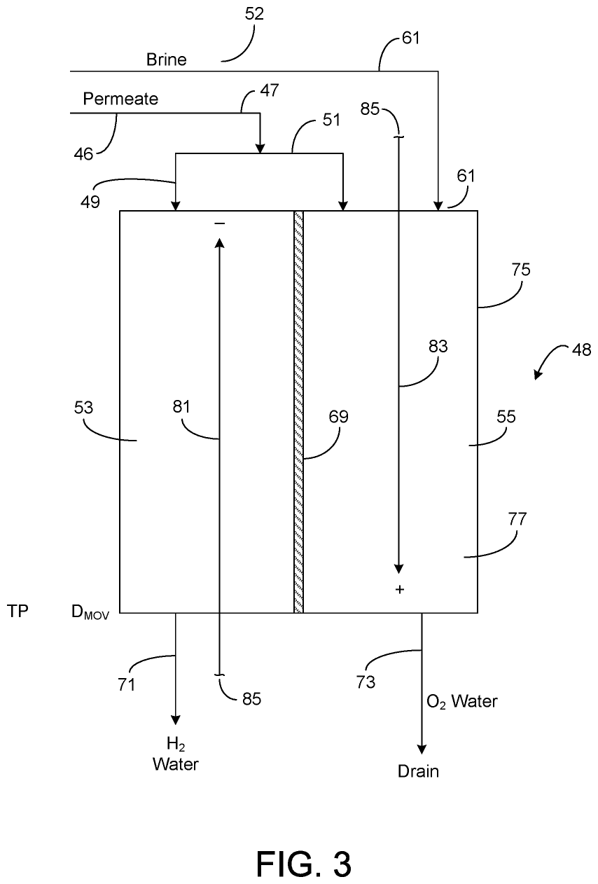

As can be seen in FIG. 2, the permeate 46 passes outwardly of the reverse osmosis filter 44 through a first outlet 45 into line 47. Ultimately, line 47 will divide into a first portion 49 and a second portion 51 so as to deliver the permeate 46 into a first compartment 53 and a second compartment 55 of ionizer 48. Specifically, portion 49 of line 47 will deliver some of the permeate into the first compartment 53. The portion 51 of line 47 will deliver this permeate into the ionizer 55. The ionizer 47 is shown in greater detail in connection with FIG. 3 herein.

Importantly, the permeate 46 exiting outlet 45 from reverse osmosis filter 44 is essentially pure water containing no contaminants, salts, or other dissolved solids. As such, it will contain virtually no ions with which to electrolysize the solution within the compartment 57 of ionizer 48. Any attempt to electrolysize such ions within the ionizer 48 would be extremely ineffective in achieving a proper hydrogenated drinking water output. As such, in order to allow the electrolysis process to be conducted properly within ionizer 48, it is necessary to introduce the salts and ions into the ionizer. In the present invention, this is achieved by introducing at least a portion of the brine 42 from outlet 50 of the reverse osmosis filter 44.

In FIG. 2, it can be seen that the permeate 52 is delivered along a line to a valve 59. Valve 59 is a three-way valve that can be moved into a position so that a portion of the brine 52 passes into line 61 and another portion of the brine 52 flows to outlet 63. Outlet 63 will assure that the unused portion of the highly contaminated and salty brine is delivered to a drain for disposal. The remaining portion of the highly salted and contaminated brine 52 will flow along line 61 so as to be discharged into a second inlet 65 into the second compartment 55 of ionizer 48. As such, the highly salted and contaminated brine 52 can mix with the permeate 46 within the compartment 55 of the ionizer 48. The result is that the very pure permeate will only reside in the first compartment 53. The mixture of the very pure permeate and the highly salted and contaminated brine 52 will reside in the second compartment 55. As such, the second compartment 55 will contain the necessary ions so as to effect the electrolysis process.

A membrane 69 is positioned between the first compartment 53 and the second compartment 55. The membrane 69 is a proton exchange membrane, such as that manufactured by DuPont under the trademark “NAFION” ™. This proton exchange membrane 69 assures that only hydrogen molecules migrate through the membrane 69 from the second compartment 55 into the first compartment 53 during the electrolysis process. As such, membrane 69 provides a “mechanical” barrier against the migration of oxygen and contaminants from the second compartment 55 into the first compartment 53.

Additionally, and furthermore, the permeate 46 will flow through line 47 and into the first compartment 53 and the second compartment 55 under a significant amount of pressure. In contrast, the brine 52 will flow through line 61 into inlet 65 and into the second compartment 55 under much less pressure. Since the fluid pressure within the first compartment 53 is greater than the fluid pressure within the second compartment 55, this pressure differential will resist any flow from the second compartment 55 into the first compartment 53. Once again, this assures that contamination of the water within the first compartment 53 is avoided since this presents a pneumatic barrier to the fluid flow from the second compartment 55 to the first compartment 53. As such, the present invention absolutely assures that the hydrogenated drinking water from the first compartment 53 is free of contamination.

The ionizer 48 includes a first outlet 71 and a second outlet 73. The first outlet 71 passes the hydrogenated drinking water from the first compartment 53. The second outlet 73 passes the oxygenated water (along with its contaminants) outwardly of the second compartment 55. The oxygenated water and the contaminants can be disposed of in any desired manner.

The process and system of the present invention, as shown in FIG. 2, achieve significant advantages over the prior art. First, the present invention allows the use of reverse osmosis for the filtering of the tap water 32. As such, the reverse osmosis filter 44 effectively removes all of the contaminants and total dissolved solids from the tap water. This extremely pure water will pass as a pure permeate 46 to the first compartment 53 and the second apartment 55 of the ionizer 48. As such, it is assured that very pure water will reside in the first compartment 53.

It is important for the present invention to avoid the waste of water and avoid the addition of expensive minerals and other substances for the purposes of enhancing the electrolytic reaction within the ionizer 48. As such, the present invention passes the highly salted and contaminated brine 52 from the reverse osmosis filter 44 into the second compartment 55 of the ionizer 48. The membrane 69 assures that the highly salted and contaminated brine 42 will not migrate into the pure water within the first compartment 53. Additionally, the pressure differential between the pure water in first compartment 53 and the contaminated water in second compartment 55 will assure (by hydraulic means) that there is no flow of contaminated water from the second compartment 55 into the first compartment 53. Since the brine from the reverse osmosis process is utilized in the present invention, there is no need to add minerals so as to effect the electrolysis process. The minerals are contained in the tap water that is originally filtered by the reverse osmosis filter 44. Additionally, since the brine 52 it is highly salted, this will assure that the electrolysis process is carried out very quickly and with a minimal amount of electricity. Ultimately, after the electrolysis process is carried out, the highly contaminated and highly salted oxygenated water can be properly disposed. Unlike the prior art, approximately 75% of the water is preserved in the process of the present invention in comparison with the 50% of water in the prior art. Since the brine is highly concentrated with salts, the footprint of the ionizer can be very small for the carrying out of the hydrogenation of the drinking water.

The ionizer 48 is particularly shown in FIG. 3. Ionizer 48 includes a container 75 having an interior volume 77. The membrane 69 is positioned between the first compartment 53 and the second compartment 55. In particular, it can be seen that the permeate 46 will pass along line 47 into portions 49 and 51 into the first compartment 53 in the second compartment 55. This permeate is highly purified water with minimal salts. The brine, on the other hand, passes along line 61 into the inlet 65 of the second compartment 55. As such, the second compartment 55 will contain both the highly pure permeate and the highly salted and contaminated brine 52.

FIG. 3 shows that there is a first conductor 81 positioned in the first compartment 53 and a second conductor 83 positioned in the second compartment 55. The first conductor 51 will pass a negative charge from power supply 85 into the first compartment 53. The second conductor 83 will pass a positive charge from power supply 85 into the second compartment 55. The charging of the first conductor 81 and second conductor 83 will charge the salts within the brine 52 within the second compartment 55 so as to cause the hydrogen molecules to migrate toward and through the membrane 69 into the first compartment 53. Ultimately, in order to create the necessary electrical conductivity between the fluids in the first compartment 53 and second compartment 55, the surfaces of the membrane 69 will need to be soaked with the respective fluids. Since the membrane 69 is a proton exchange membrane, only hydrogen molecules can migrate from the highly salted and contaminated water within the second compartment 55 to the first compartment 53. As such, only hydrogen molecules will bubble through and dissolve in the water in the first compartment 53. Ultimately, this hydrogenated drinking water can be discharged through outlet 71 for consumption by a user. The residual oxygenated water will pass through outlet 73 for disposal.

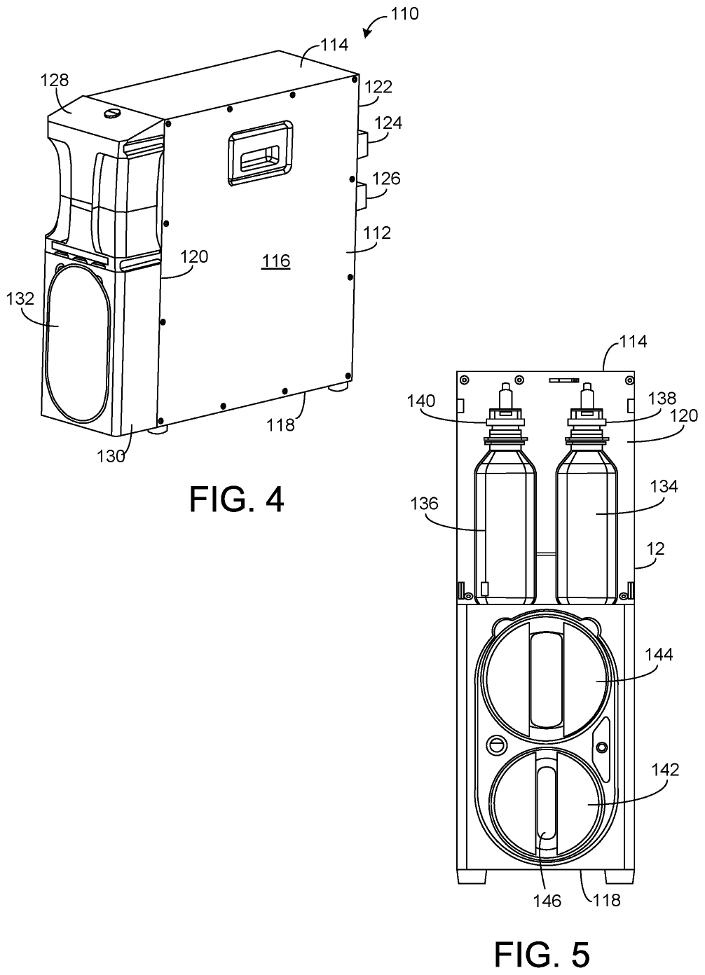

Referring to FIG. 4, there shown the water filtering and mineralization system 100 in accordance with the teachings of the present invention. The water filtering and mineralization system 100 includes a housing 112 having a generally rectangular cubicle configuration. In particular, housing 112 has upper surface 114, side wall 116, bottom 118, front wall 120 and back wall 122. Walls 114, 116, 118 and 120 enclose the assembly for the treatment of water. In particular, in FIG. 4, the back wall 122 includes an inlet connection 124. Inlet connection 124 is adapted to allow tap water to be introduced into the interior of the housing 112. A support 126 is illustrated below the inlet 124. Support 126 is configured so as to support a line extending for the introduction of tap water into the housing 112. An outlet for the mineralized drinking water is positioned on a side of the inlet 124 (not shown in FIG. 4).

In FIG. 4, it can be seen that there is a first cover 128 that is positioned against the front wall 120 of the housing 112. This first cover 128 extends over the mineral or supplement-containing bottles used in the dosing of minerals into the drinking water. Cover 128 is removably positioned adjacent to the upper surface 114 of the housing 112. A second cover 130 is positioned against the front wall 120 of the housing 112 and extends so as to be positioned generally adjacent to the bottom 118 of the container 112. Second cover 130 is intended to removably cover the filters contained within the housing 112. In particular, second cover 130 can include a flap or surface 132 that can be specifically removed from the cover 130 so as to allow direct access to the filters within the housing 112.

FIG. 5 shows the configuration at the front wall 120 of the housing 112. In FIG. 5, it can be seen that there is a first bottle 134 and a second bottle 136 that are positioned adjacent to the top 114 of housing 112. Each of the bottles 134 and 136 are connected to container receptacle assemblies 138 and 140. The bottles 134 and 136 are removably connected respectively to the container receptacle assemblies 138 and 140. The bottles 134 and 136 can contain minerals and/or supplements therein. In particular, one of the bottles can contain one type of mineral and the other bottle can contain another type of mineral. As such, through a control system, the filtered drinking water can be dosed with a desired quantity of the minerals or supplements from bottle 134 and a desired quantity of the minerals or supplements from bottle 136. If necessary, the control system can be actuated so as to prevent any of the minerals in either of the bottles 134 and 136 from entering the system. The controls can also be adapted to control the rate at which the minerals pass from the bottles 34 and 36 into the filtered water within the interior of the housing 112.

FIG. 5 shows the front wall 120 of the housing 112 with the second cover 130 removed. The removal of the second cover 130 exposes a first filter 142 and a second filter 144. The end of the first filter 142 is exposed at the front wall 120 so that the handle 146 of first filter 142 can be accessed. As such, if it is desired to remove or repair the first filter 142, it is only necessary to remove the cover 130 (or flap 132), access the handle 146, rotate the handle 146 and slide the first filter 142 out of position. A similar action can occur with respect to the second filter 144.

The first filter 142, in the preferred embodiment of the present invention, is a pretreatment filter or a carbon filter. In the preferred embodiment the present invention, the second filter 144 is a reverse osmosis filter. When the first filter 142 is a pretreatment filter, the tap water entering the inlet 124 of the housing 112 will flow in this pretreatment filter so that the pretreatment filter can provide an initial treatment to the water and remove sediment and other contaminants therefrom. The water will flow from the pretreatment filter 142 into the reverse osmosis filter 144 for further removal of any metals, chemicals, contaminants or ions from the water. Importantly, each of the first filter 142 and second filter 144 is located adjacent to the bottom 118 of the housing 112. The first filter 142 and the second filter 144 are also located below the bottles 134 and 136 and located below the container receptacle assemblies 138 and 140. This arrangement greatly improves efficiency in terms of the management of the filters and the bottles. The ease of accessibility of the filters 142 and 144 greatly improves efficiency in the water treatment process and the repair or replacement of the filters.

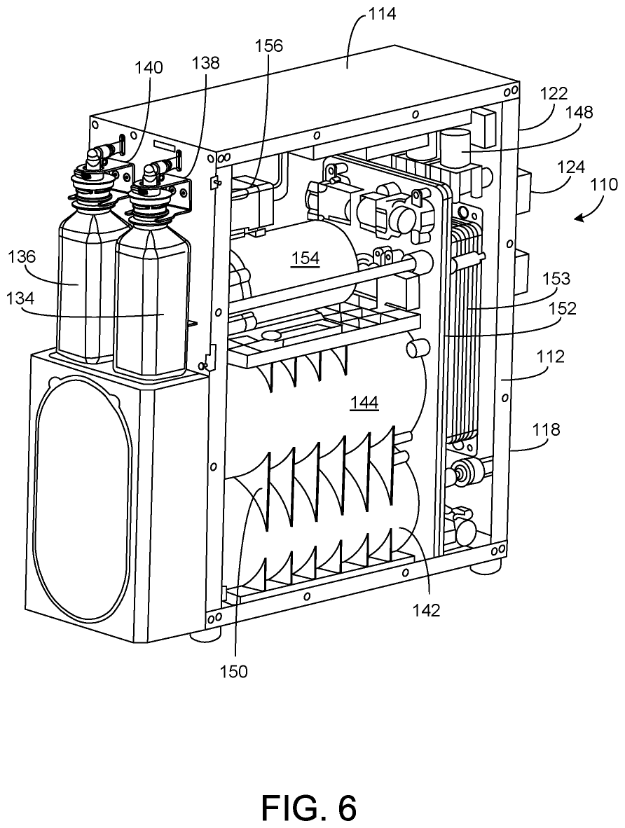

FIG. 6 further shows the water filtering and mineralization system 110 of the present invention. In particular, FIG. 6 shows that the inlet 124 at the back wall 122 of housing 112 has a valve 148 associated therewith. Valve 148 is movable between an open position and a closed position. In the closed position, tap water flow into the interior of housing 112 is blocked. In the open position, tap water flow into the interior of the housing 112 is permitted. The valve 148 is easily accessible so as to allow water flow to be immediately turned off in the event that leaks should occur or in the event that leak detection equipment within the interior of the housing 112 should signal a leak. The present invention avoids the need to locate the source of the water flow in order to stop the water flow to the water filtering and mineralization system 110.

In FIG. 6, it can be seen that the first filter 142 and the second filter 144 extend longitudinally across the housing 112. Various brackets 150 support these filters in their desired position. A manifold 152 is illustrated as positioned adjacent to the back wall 118 of the housing 112. Manifold 152 extends in a generally vertical orientation. The manifold 152 is positioned between the first and second filters 142 and 144 and the back wall 118. Manifold 152, as will be explained hereinafter, serves to receive the flow of the mineral or supplement-containing liquid as pumped from the bottles 134 and 136 and mixes this mineral-containing liquid in the manifold 152 with the filtered water from the first and second filters 142 and 144.

Since it is necessary to pressurize the pre-treated water in order to have the pretreatment water flow through the reverse osmosis filter 144, a diaphragm pump 154 is positioned in the interior of housing 112. Diaphragm pump 154 will receive the pretreated water from the first filter 142, pressurize the water, and then pass the water, under pressure, through the second filter 144 (the reverse osmosis filter). The filtrate from the second filter 144 can then flow into the manifold 152 for the purposes of mixing the minerals with the demineralized water.

It is very important to control the rate and amount of the mineral or supplement-containing liquid from the bottles 134 and 136 that enters the filtered water. As such, a peristaltic pump 156 is used in association with each of the bottles 134 and 136. Peristaltic pump 156 operates in a conventional manner so as to assure the delivery of a desired quantity or rate of mineral-containing liquid to the manifold 152. Peristaltic pumps, as they are known, utilize flexible tubes and rollers so as to pass a fixed amount of fluid flow. The peristaltic pump 156 avoids the use of any valves. Suitable servomotors can be utilized in conjunction with the peristaltic pump 156 so as to control the rate at which the mineral-containing liquid is discharged into the manifold 152.

FIG. 6 further shows that the water filtering and mineralization system 110 has special container receptacle assemblies 138 and 140 positioned adjacent to the top 114 of housing 112. Peristaltic pump 156 is positioned on the interior of housing 112 and adjacent to these container receptacle assemblies 138. The close positioning of the peristaltic pump 156 to the container receptacle assemblies 138 and 140 assures the proper operation of the peristaltic pump and the proper delivery of fluid from the bottles 134 and 136. If the peristaltic pump 156 were not positioned adjacent to the container receptacle assemblies 138 and 140, there could be more dosing error associated with the delivery of the mineral-containing liquid from the bottles 134 and 136.

In FIG. 6, the ionization chamber 153 is particularly illustrated. As mounted to the wall 18 of the housing 12. Ionization chamber 153 extends in a generally vertical configuration. The ionization chamber 153 will have a construction described, in greater detail, in association with the following figures. The ionization chamber 153 is adapted to receive the filtered water output and the brine output from the reverse osmosis filter 144.

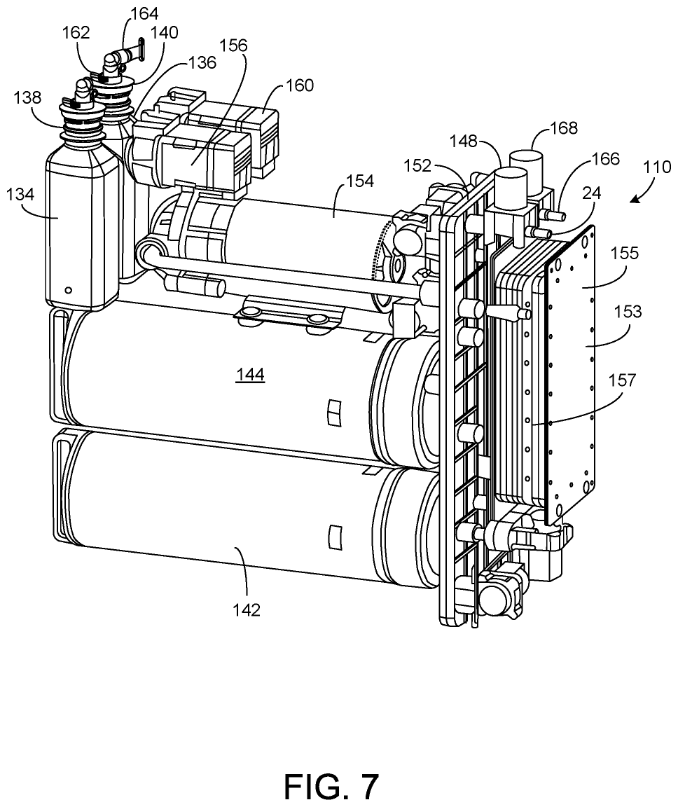

FIG. 7 shows the interior of the water filtering and mineralization system 110 of the present invention. In particular, FIG. 7 shows the first filter 142 and the second filter 144 arranged one on top of another adjacent to the bottom of the housing. Bottles 134 and 136 are positioned adjacent to the top of the housing. The peristaltic pump 156 is positioned adjacent to the container receptacle assembly 138. Peristaltic pump 160 is positioned adjacent to the container receptacle assembly 140. A line or conduit will extend from the elbows 162 and 164 of the respective container receptacle assemblies 138 and 140 to the respective peristaltic pumps 156 and 160.

FIG. 7 shows the configuration of the inlet 124 and the outlet 166. Inlet 124 receives the tap water into the interior of the housing. Outlet 166 allows for the discharge of mineralized drinking water from the housing. Valve 148 extends outwardly from the inlet 124 and operates to control the flow of water through the inlet 124. Valve 168 is associated with the outlet 166 and can control the flow of mineralized drinking water out of the outlet 166. Initially, the tap water will flow through the inlet 124 and down to the first filter 142 for pretreatment purposes. The outlet of the first filter 142 will flow to the diaphragm pump 154 for pressurization prior to passing to the second filter 144 (the reverse osmosis filter). Ultimately, the filtered water from the reverse osmosis filter 144 will be devoid of minerals. It can then flow into the manifold 152 for mixing with a mineral-containing liquid from bottles 134 and 136. After mixing, the manifold 152 will then pass the flow of the mineralized drinking water to the outlet 166. The manifold 152 can be connected to the outlet 166 of the housing 112 or it can be the outlet of the housing 112.

FIG. 7 shows that the ionization chamber 153 is mounted adjacent to the manifold 152. The ionization chamber 153 includes a housing 155 surrounding a plurality of plates and electrodes 157. Ultimately, the ionization chamber 153 will have a construction similar to that as described in association with the following drawings.

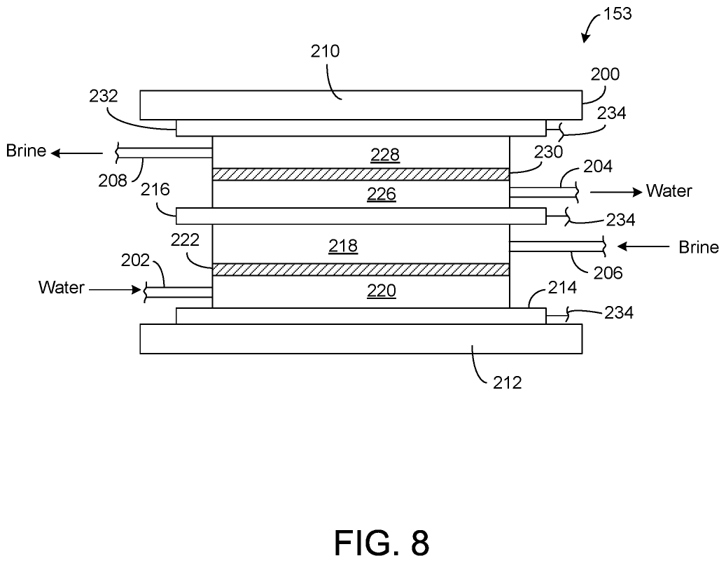

FIG. 8 illustrates the operation of the ionization chamber 153 of the present invention. In particular, the ionization chamber 153 includes a housing 200 having a first ingress 202 and a first egress 204. The first ingress 202 is adapted to pass filtered water into the housing 200. The second egress 204 is adapted to pass the hydrogenated water from the housing 200. The housing 200 further includes a second ingress 206 and a second egress 208. The second egress is adapted to pass the brine from the reverse osmosis filter into the housing 200. The second egress 208 is configured so as to pass brine from the housing 200 following the hydrogenation of the water within the housing 200. In particular, the housing 200 is illustrated as having a first wall 210 and a second wall 212. Walls 210 and 212 can be suitably mounted within the interior of the housing 112 of the water filtering and mineralization system. Suitable fasteners can be included on either of the walls 210 and 212 so as to facilitate the installation of the ionization chamber 153.

A first electrode 214 is positioned in the housing 200 and adapted to pass an electrical charge of a polarity. The first electrode 214 is illustrated as being positioned adjacent to the wall 212 of the housing 200. A second electrode 216 is positioned in the housing. The second electrode 216 is adapted to pass an electrical charge of a different polarity than the polarity that is passed to the first electrode 214. A first brine chamber 218 is formed in the housing 200. The first brine chamber 218 communicates with a second ingress 206, and ultimately with the second egress 208 of the housing 200. A filtered water chamber 220 is positioned in the housing 200. The filtered water chamber 200 communicates with the first ingress 202, and ultimately with the first egress 204. An ion exchange membrane 222 is positioned between the first brine chamber 218 and the first filtered water chamber 220. The first ion exchange membrane is adapted to pass hydrogen ions from the brine to the filtered water as the electrical charges are applied to the first electrode 214 and the second electrode 216.

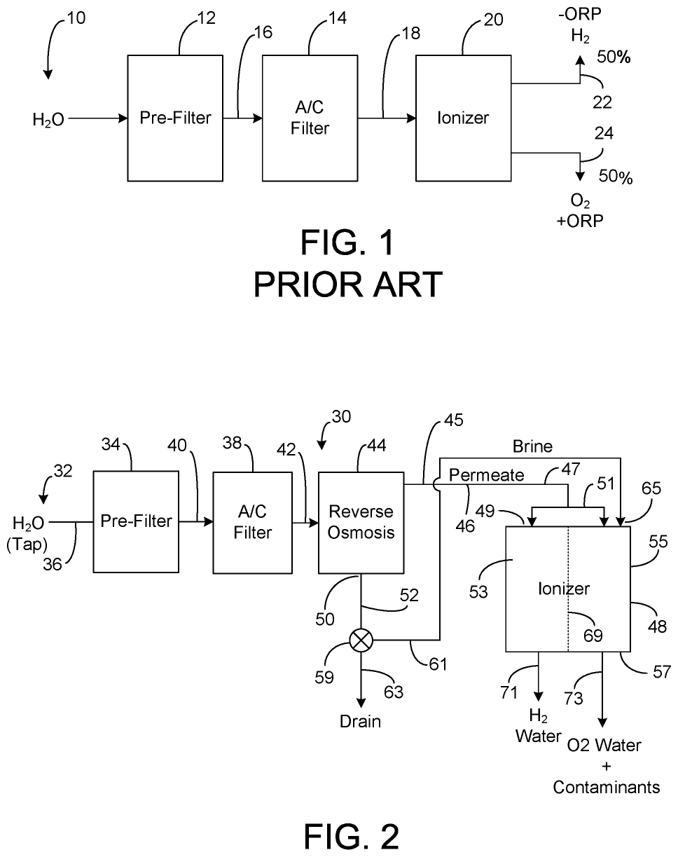

Each of the first electrode 214 and the second electrode 216 is in the nature of a plate positioned so as to extend across at least a portion of the housing 200. The first brine chamber 218 is defined by the plate of the electrode 216 and the first ion exchange membrane 222. The first filtered water chamber 220 is defined by the first ion exchange membrane 222 and the plate of the electrode 214. As will be described hereinafter, the first brine chamber 218 and the first filtered water chamber 220 will include a panel having a channel of a circuitous configuration. As such, as water enters the filtered water chamber 220 through the first ingress 202, it will flow in a circuitous path on one side the ion exchange membrane 222. Similarly, the brine from the reverse osmosis filter can pass through the second ingress 206 so as to flow through a plate within the brine chamber 218 in a circuitous path opposite to the circuitous path of the filtered water in the filtered water chamber 220. This will be on an opposite side the ion exchange membrane 222 from the filtered water in the filtered water chamber 220. As electrical charges of different polarities are applied to the electrodes 214 and 216, this will create an electrolysis effect (as described herein previously in association of FIGS. 1-3) such that hydrogen ions from the brine and the brine chamber 218 will pass through the ion exchange membrane 222 to the filtered water in the filtered water chamber 220.

FIG. 8 shows that these chambers can be arranged in a stacked configuration. As can be seen, there is a second filtered water chamber 226 and a second brine chamber 228 arranged on opposite sides of a second ion exchange membrane 230. A third electrode 232 will be placed adjacent to the wall 210 of the housing 200. As can be seen, the second brine chamber 228 will be defined between the second electrode 232 and the second ion exchange membrane 230. The second brine chamber 228 will communicate with the second egress 208 so as to allow used brine to be passed outwardly of the housing 200. The second filtered water chamber 226 is defined between the second electrode 216 and the second ion exchange membrane 230. Ultimately, this will allow water to pass to the first egress 204 so that hydrogenated water can be delivered outside of the housing 200. As will be described hereinafter, the brine chambers 218 and 228 will communicate with each other so that there is a path of the flow of brine through these chambers prior to being released through the second egress 208. Similarly, the first filtered water chamber 220 will communicate with the second filtered water chamber 226 so that there is a circuitous flow of the filtered water throughout the housing 200 before the hydrogenated water is ultimately released through the first egress 204.

FIG. 8 shows that there is a power supply 234 that is connected to the first electrode 214 and also to the second electrode 216. Similarly, the power supply 234 can be connected to the third electrode 234.

As was described herein previously in association with FIGS. 1-3, the present invention operates to preserve water resources by utilizing the waste brine from the reverse osmosis filter. Furthermore, the present invention assures a complete electrolysis of the water within the filtered water chambers 220 and 226 because of the circuitous flow of the filtered water in close relation to the circuitous flow of the brine in the brine chambers 218 and 228. This maximizes the amount of electrolysis that can occur during the respective flows of water so that a maximum hydrogenation of the water occurs prior to the release of the hydrogenated water through the first egress 204. This compact configuration occupies a relatively small footprint within the interior of the housing 110 of the water filtering and mineralization system shown hereinbefore.

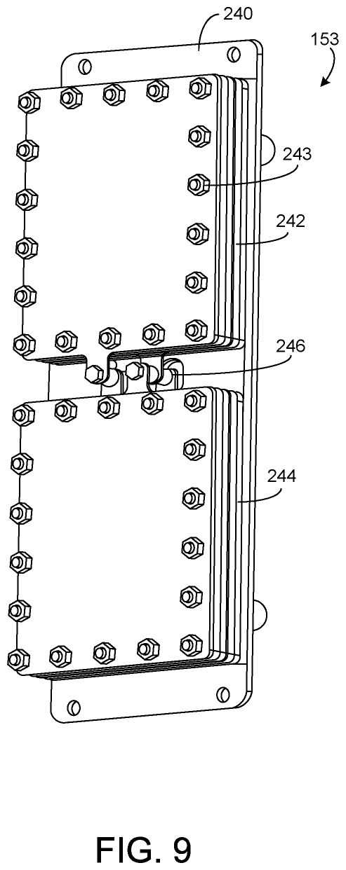

FIG. 9 illustrates the ionization chamber 153 of the present invention. In particular, ionization chamber 153 includes a plate 240 that supports a first housing 242 and a second housing 244 thereon. The first housing 242 and the second housing 244 will communicate with each other so that the flow of the filtered water and the flow of the brine continues through further circuitous paths of the various panels that occur within a filtered water chamber and the brine chamber therein. Terminals 246 are provided in relation to the ionization chamber 153 so as to pass electricity to the various electrodes within the housing 242 and 244. Each of the housings 242 and 244 will have a configuration similar to that shown in FIG. 8 hereinbefore. A plurality of fasteners 248 are configured so as to secure the plate of the housing 242 together with each of a chambers and electrodes. A similar configuration occurs with the second housing 244.

Importantly, the arrangement of the first housing 242 and the second housing 244, in communication with each other, further assures that there is a continuous and circuitous flow of brine and filtered water throughout the interior of the ionization chamber 153. If it is found, after experimentation, that additional contact time is required between the brine and the filtered water, then additional housings, such as housings 242 and 244, can be applied to the plate 240. This allows the present invention to be adaptable to the flow rate and volume of hydrogenated water that is desired to be produced from the water filtering and mineralization system 110 of the present invention.

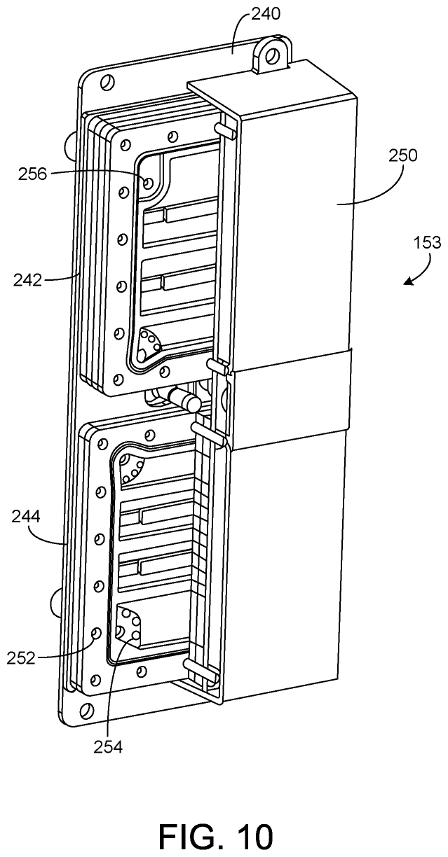

FIG. 10 illustrates that there is a cover 250 that is positioned so as to be secured to the plate 240 of the ionization chamber 153. Cover 250 encloses each of the housings 242 and 244 within an interior thereof. FIG. 10 further shows that each of the plates and panels used within each of the housings 242 and 244 includes single hole openings 252 so as to allow the fasteners 248 to secure the sandwiched configuration together. FIG. 10 further shows that various fasteners are used so as to secure the corners 254 of the ion exchange membrane within the assembly. The brine and/or filtered water can flow through the pathways 256 so as to move between the various chambers therein.

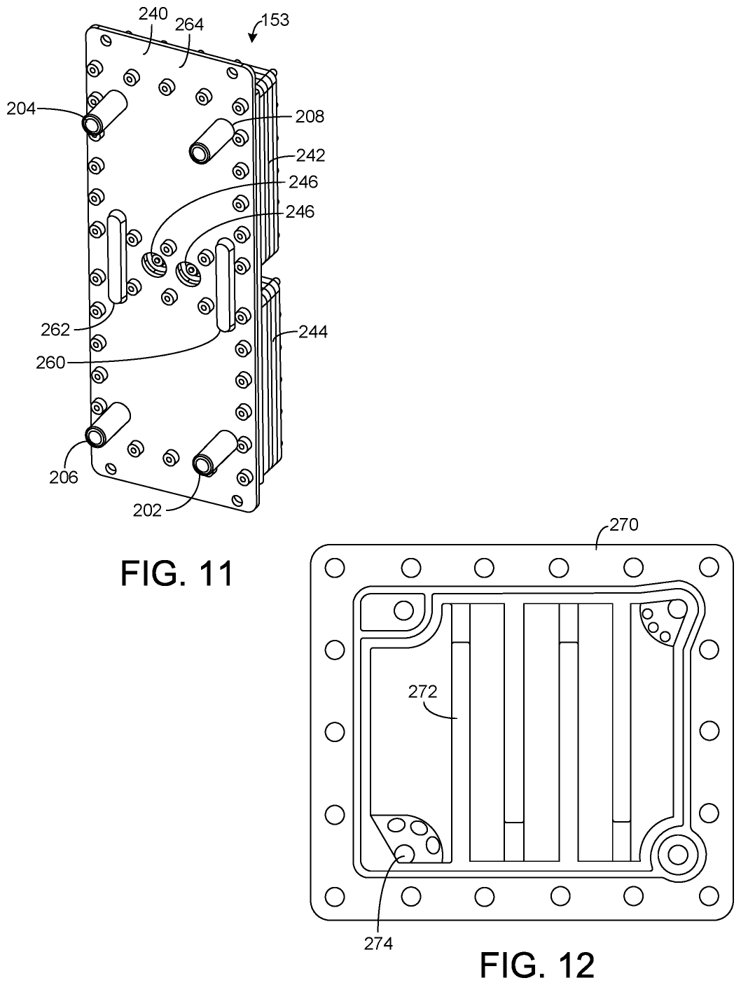

FIG. 11 shows a rearward view of the ionization chamber 153 of the present invention. In particular, FIG. 11 shows the first ingress 202, the second ingress 206, the first egress 204 and the second egress 208. As was stated herein previously, the first ingress 202 allows filtered water to be introduced into the ionization chamber 153. The second ingress 206 allows the brine from the reverse osmosis filter to be introduced within the ionization chamber 153. The first egress 204 allows the hydrogenated water to be released from the interior of the ionization chamber 153. The second egress 208 allows the spent brine to be released from the ionization chamber 153.

FIG. 11 further shows that there are flow pathways 260 and 262 which allow the filtered water and the brine, respectively, to pass between the housings 242 and 244. This facilitates the ability to create a “modular” configuration of such housings and ionization chambers. Terminals 246 can be connected at the rear face 264 of the plate 240.

Within the concept of the present invention, the first egress 204 and the second egress 208 can pass outwardly of the housing 110. This allows the first egress 204 to be connected to a faucet so as to deliver hydrogenated water for consumption. The second egress 200 made allows the spent brine to be connected to a drain system so that the spent brine can be disposed of through a conventional sewage system.

FIG. 12 shows the configuration of a panel 270 as used for the flow of brine and filtered water throughout the ionization chamber 153 of the present invention. As can be seen, the panel 270 can be placed within each of the respective filtered water chambers and the brine chambers. This allows the flow of water to pass through the channel 272 therein. Channel 272 is a generally serpentine configuration. As such, the liquid, whether it be brine or filtered water, can flow from the opening 274 into the channel 272. The panel 270 can be arranged within each of the brine chambers and the filtered water chambers so that the flow of the brine and the filtered water will run opposite to each other and so as to maximize the amount of contact time between the brine and the filtered water. The ion exchange membrane, being a proton exchange membrane, will certainly separate the respective panels within the brine chambers and the filtered water chambers.

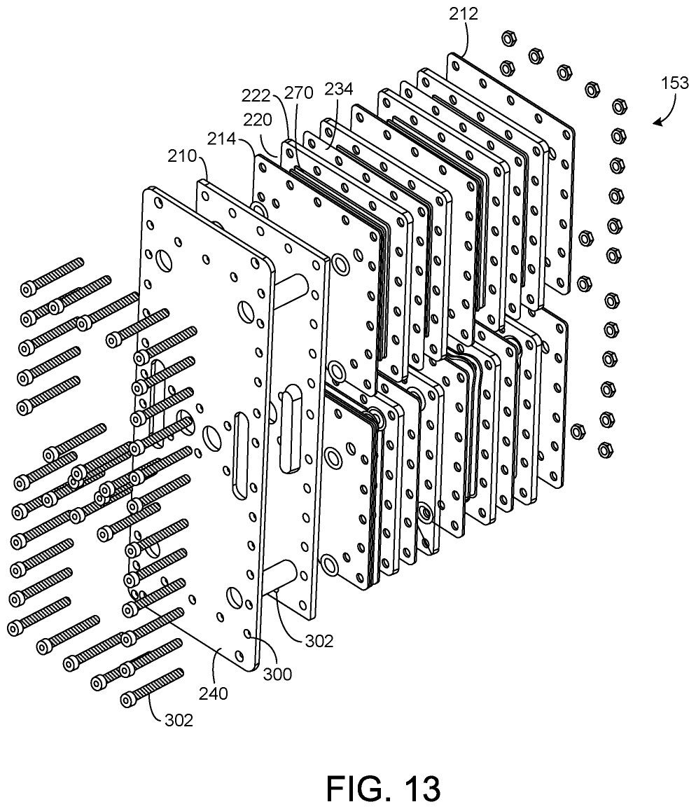

FIG. 13 shows an exploded view of the ionization chamber 153 of the present invention. Initially, it can be seen that the panel 240 has a plurality of holes 300 that are adapted to allow screw-type fasteners 302 to secure the ionization chamber 153 together in a sandwiched configuration. The plate 210 can be positioned in spaced relation to the plate 240 by using spacers 302. The electrode 214 will be positioned adjacent to the plate 210. The ion exchange membrane 222 is illustrated as being in spaced relationship to the first electrode 214. As such, the first electrode 214 and the first ion exchange membrane 222 define the filtered water chamber 220. The panel 270 (as shown in FIG. 12 hereinbefore) will be placed within the filtered water chamber 220. Another electrode 234 is provided so as to define the brine chamber 218. As such, the membrane 222 will separate the brine chamber 234 from the filtered water chamber 226 from the brine chamber 220. The system continues until it is built in the nature of one of the housings 242 and 244, as shown, as shown in FIG. 9. Ultimately, a plate 212 will be used to secure each of the panels, electrodes, and plates in a sandwiched configuration.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents

I claim:

1. An ionization chamber for use with a water filtration system, the ionization system comprising:
a housing having a first ingress and the second ingress, the first ingress adapted to pass filtered water into said housing, the second ingress adapted to pass a brine into said housing, said housing having a first egress and a second egress, the first egress adapted to pass hydrogenated water from said housing, the second egress adapted to pass the brine from said housing;
a first electrode positioned in said housing, said first electrode adapted to pass an electrical charge of a polarity;
a second electrode positioned in said housing, said second electrode adapted to pass an electrical charge of another polarity;
a first brine chamber formed in said housing, said first brine chamber communicating with the second ingress and the second egress of said housing;
a first filtered water chamber positioned in said housing, said first filtered water chamber communicating with the first ingress and the first egress; and
an ion exchange membrane positioned between said first brine chamber and said first filtered water chamber, said ion exchange membrane adapted to pass hydrogen ions from the brine to the filtered water as the electrical charges are supplied to the first electrode and the second electrode.

2. The ionization chamber of claim 1, each of said first electrode and said second electrode being a plate positioned so as to extend across said housing.

3. The ionization chamber of claim 2, said first brine chamber being defined by the plate of said first electrode and the first ion exchange membrane.

4. The ionization chamber of claim 3, said first filtered water chamber being defined by said first ion exchange membrane and the plate of said second electrode.

5. The ionization chamber of claim 1, wherein said first brine chamber comprises a panel sandwiched between said first electrode and said first ion exchange membrane, said panel having at least one channel therein, the channel communicating with the second ingress and the second egress.

6. The ionization chamber of claim 5, wherein the at least one channel of said first brine chamber is of a serpentine configuration, the serpentine configuration adapted to cause the brine to flow along a path of the serpentine configuration.

7. The ionization chamber of claim 5, wherein said first filtered water chamber comprises another panel sandwiched between said first ion exchange membrane and said second electrode, the another panel having at least one channel therein, the at least one channel communicating with the first ingress and the first egress.

8. The ionization chamber of claim 7, wherein the at least one channel of the another panel of said first filtered water chamber has a serpentine configuration, the serpentine configuration adapted to cause the filtered water to flow along the path of the serpentine configuration.

9. The ionization chamber of claim 1, further comprising:
a power supply electrically connected to said first electrode and said second electrode.

10. The ionization chamber of claim 1, further comprising:
a second brine chamber formed in said housing on the side of said second electrode opposite said first filtered water chamber;
a second ion exchange membrane positioned in said housing on a side of said second brine chamber opposite said second electrode;
a second filtered water chamber formed in said housing on the side of said second ion exchange membrane opposite said second brine chamber; and
a third electrode positioned in said housing on a side of said second filtered water chamber opposite said second ion exchange membrane, said third electrode adapted to pass an electrical charge of a polarity opposite to a polarity of the electrical charge of said second electrode.

11. The ionization chamber claim 10, wherein said second brine chamber communicates with either of said first brine chamber or with the second ingress, the second brine chamber communicating with the second egress.

12. The ionization chamber of claim 10, wherein said second filtered water chamber communicates with either said first filtered water chamber or with the first ingress, said second filtered water chamber in communication with said first egress.

13. The ionization chamber of claim 1, further comprising:
a second brine chamber and a second ion exchange membrane and a second filtered water chamber and a third electrode arranged in a sandwiched configuration, the sandwiched configuration positioned to a side of said first brine chamber and the first ion exchange membrane and the first filtered water chamber and the first and second electrodes, the second brine chamber being in communication with said first brine chamber, the second filtered water chamber in communication with the first filtered water chamber.

14. The ionization chamber of claim 1, wherein said first ion exchange membrane is a proton exchange membrane.

15. An apparatus for filtering a hydrogenating drinking water, the apparatus comprising:
a housing having a reverse osmosis filter positioned therein, the reverse osmosis filter adapted to receive tap water and to pass a filtered water and a brine therefrom; and
an ionization chamber positioned in said housing, said ionization chamber having a first ingress and a second ingress, the first ingress adapted to pass filtered water into said ionization chamber, the second ingress adapted to pass the brine into said ionization chamber, said ionization chamber having a first egress and a second egress, the first egress adapted to pass hydrogenated water from said ionization chamber, the second egress adapted to pass the brine from said ionization chamber, said ionization chamber comprising:
a first electrode positioned in said ionization chamber, said first electrode adapted to pass an electrical charge of a polarity;
a second electrode positioned in said ionization chamber, said second electrode adapted to pass an electrical charge of another polarity;
a first brine chamber formed in said ionization chamber, said first brine chamber communicating with the second ingress and the second egress of said ionization chamber;
a first filtered water chamber positioned in said ionization chamber, said first filtered water chamber communicating with the first ingress and the first egress; and
an ion exchange membrane positioned between said first brine chamber and said first filtered water chamber, said ion exchange membrane adapted to pass hydrogen ions on the brine to the filtered water as the electrical charges are applied to the first electrode and the second electrode.

16. The apparatus of claim 15, wherein each of said first electrode and said second electrode is a plate, the first brine chamber being defined by the plate of said first electrode and the first ion exchange membrane, the first filtered water chamber being defined by the first ion exchange membrane and the plate of the second electrode.

17. The apparatus of claim 15, wherein said first brine chamber comprises a panel sandwiched between the first electrode and the ion exchange membrane, the panel having at least one channel therein, the channel communicating with the second ingress and the second egress, wherein the at least one channel of said first brine chamber is of a serpentine configuration, the serpentine configuration adapted to cause the brine to flow along a path of the serpentine configuration.

18. The apparatus of claim 17, wherein said first filtered water chamber comprises another panel sandwiched between the first ion exchange membrane and the second electrode, the another panel having at least one channel therein, the at least one channel communicating with the first ingress and the first egress, wherein the at least one channel of the another panel of said first filtered water chamber has a serpentine configuration, the serpentine configuration adapted to cause the filtered water flow along a path of the serpentine configuration.

19. The/apparatus of claim 15, further comprising:
a power supply electrically connected to said first electrode and said second electrode.

20. The apparatus of claim 15, wherein said ionization chamber extends vertically within said housing, the first and second egresses extending outwardly of said housing.
